(19) United States
(12) Patent Application Publication
(10) Pub. No.: US 2023/0044543 A1
(43) Pub. Date: Feb. 9, 2023

(54) MOLD REPLACEMENT METHOD

(71) Applicant: TOYOTA JIDOSHA KABUSHIKI KAISHA, Toyota-shi (JP)

(72) Inventors: Hirotsune WATANABE, Miyoshi-shi (JP); Masaomi MITSUTAKE, Nissin-shi (JP)

(73) Assignee: TOYOTA JIDOSHA KABUSHIKI KAISHA, Toyota-shi (JP)

(21) Appl. No.: 17/861,891

(22) Filed: Jul. 11, 2022

(30) Foreign Application Priority Data
Aug. 4, 2021 (JP) 2021-128304

(51) Int. Cl. B29C 45/17; B29C 45/06

(52) U.S. Cl. CPC B29C 45/1756; B29C 45/062; B29C 45/1742

(57) ABSTRACT

A mold replacement method that can contribute to simplification of unloading a fixed mold and a movable mold when the fixed mold and the movable mold are replaced. A mold replacement method includes coupling a fixed mold to a movable mold in a vertically divided molding machine, releasing a coupled state between the movable mold and a movable mold equipment base, rotating the fixed mold and the movable mold by a rotating mechanism for rotating a fixed mold equipment base, and disposing the movable mold above the fixed mold, releasing the coupled state between the fixed mold and the fixed mold equipment base, and unloading the fixed mold and movable mold from a fixed mold equipment base while a protrusion protruding outward from the movable mold is being supported by a fork of a lifting and lowering device.

### CROSS REFERENCE TO RELATED APPLICATIONS

This application is based upon and claims the benefit of priority from Japanese patent application No. 2021-128304, filed on Aug. 4, 2021, the disclosure of which is incorporated herein in its entirety by reference.

### BACKGROUND

The present disclosure relates to a mold replacement method.

As disclosed in Japanese Unexamined Patent Application Publication No. 2005-144802, a common vertically divided molding machine opens and closes molds by moving a movable mold in a lateral direction relative to a fixed mold. In such a vertically divided molding machine, it is necessary to replace the fixed mold and the movable mold according to a mold to be molded.

### SUMMARY

The applicant has found the following problem. In a common vertical dividing molding machine, when a fixed mold and a movable mold are replaced, the fixed mold and the movable mold are separately lifted up and unloaded by using a large scale device such as a hoist crane. Therefore, when the fixed mold and the movable mold are replaced, unloading the fixed mold and the movable mold is complicated.

The present disclosure has been made in view of such a problem, and achieves a mold replacement method that can contribute to simplification of unloading a fixed mold and a movable mold when the fixed mold and the movable mold are replaced.

In an aspect of the present disclosure, a mold replacement method of a vertically divided molding machine including:
a fixed mold;
a fixed mold equipment base to which the fixed mold is coupled;
a movable mold; and
a movable mold equipment base to which the movable mold is coupled and which is configured to be capable of being brought close to and being separated from the fixed mold equipment base. The mold replacement method includes:
coupling the fixed mold to the movable mold;
releasing a coupled state between the movable mold and the movable mold equipment base;
rotating the fixed mold and the movable mold in the coupled state by a rotating mechanism for rotating the fixed mold equipment base, and disposing the movable mold above the fixed mold;
releasing the coupled state between the fixed mold and the fixed mold equipment base; and
unloading the fixed mold and movable mold in the coupled state from the fixed mold equipment base while a protrusion protruding outward from the movable mold is being supported by a fork of a lifting and lowering device.

The above mold replacement method may further include:
coupling the fixed mold to the movable mold;
loading, in the fixed mold equipment base, the fixed mold and the movable mold in the coupled state while the protrusion of the movable mold disposed above the fixed mold is being supported by the fork of the lifting and lowering device;
coupling the fixed mold to the fixed mold equipment base;
rotating the fixed mold and the movable mold in the coupled state by the rotating mechanism, and disposing the fixed mold and the movable mold side by side; and
coupling the movable mold to the movable mold equipment base.

In the above mold replacement method, the lifting and lowering device may be provided on a carriage.

The above mold replacement method may further include: inserting the carriage into an insertion part formed in a lower part of the fixed mold equipment base when the carriage is brought close to the fixed mold equipment base.

According to the present disclosure, it is possible to achieve a mold replacement method that can contribute to simplification of unloading a fixed mold and a movable mold when the fixed mold and the movable mold are replaced.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows a vertically divided molding machine as viewed from a positive side of an X-axis according to an embodiment;

FIG. 2 shows the vertically divided molding machine as viewed from a positive side of a Z-axis according to the embodiment;

FIG. 3 shows the vertically divided molding machine as viewed from a negative side of a Y-axis according to the embodiment;

FIG. 4 is a view of a state in which a movable mold is removed from a movable mold equipment base, as viewed from the positive side of the X-axis, in a mold replacement method of the vertically divided molding machine according to the embodiment;

FIG. 5 is a view showing a state in which the fixed mold and the movable mold which are coupled to each other are rotated, as viewed from the positive side of the X-axis, in the mold replacement method of the vertically divided molding machine according to the embodiment;

FIG. 6 is a view showing a state in which the fixed mold and the movable mold which are coupled to each other are rotated, as viewed from the negative side of the Y-axis, in the mold replacement method of the vertically divided molding machine according to the embodiment;

FIG. 7 is a view showing a state in which a protrusion of the movable mold is placed on a fork of a lifting and lowering device, as viewed from the positive side of the X-axis, in the mold replacement method of the vertical dividing molding machine according to the embodiment;

FIG. 8 is a view showing a state in which the protrusion of the movable mold is placed on the fork of the lifting and lowering device, as viewed from the positive side of the Z-axis, in the mold replacement method of the vertical dividing molding machine according to the embodiment;

FIG. 9 is a view showing a state in which the fixed mold and the movable mold which are coupled to each other are lifted, as viewed from the positive side of the X-axis, in the mold replacement method of the vertically divided molding machine according to the embodiment; and

FIG. 10 is a view showing a state in which the fixed mold and the movable mold which are coupled to each other is unloaded, as viewed from the positive side of the X-axis, in the mold replacement method of the vertically divided molding machine according to the embodiment.

### DESCRIPTION OF EMBODIMENTS

Hereinafter, a specific embodiment to which the present disclosure is applied will be described in detail with reference to the drawings. However, the present disclosure is not limited to the following embodiment. In order to clarify the description, the following description and drawings have been appropriately simplified.

First, a basic structure of the vertically divided molding machine according to this embodiment will be briefly described. In the following description, a three-dimensional (XYZ) coordinate system will be used for clarification of the description. Here, a positive side of an X-axis is the right side of the vertically divided molding machine, and a negative side of the X-axis is the left side of the vertically divided molding machine. A positive side of a Y-axis is the front side of the vertically divided molding machine, and a negative side of the Y-axis is the rear side of the vertically divided molding machine. A positive side of a Z-axis is the upper side the vertically divided molding machine, and a negative side of the Z-axis is the lower side the vertically divided molding machine.

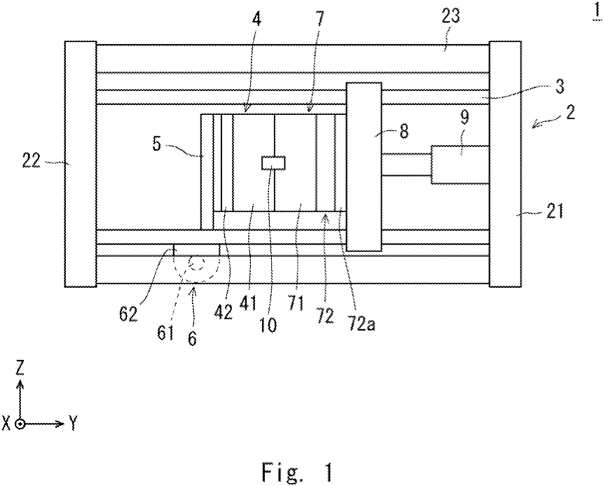

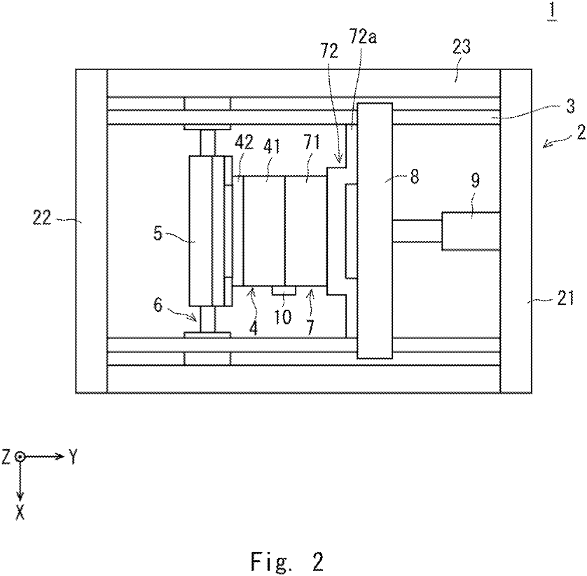

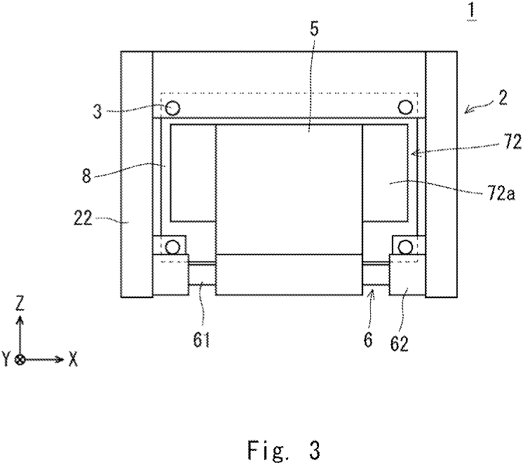

FIG. 1 shows the vertically divided molding machine according to this embodiment as viewed from the positive side of the X-axis. FIG. 2 shows the vertically divided molding machine according to this embodiment as viewed from the positive side of the Z-axis. FIG. 3 shows the vertically divided molding machine according to this embodiment as viewed from the negative side of the Y-axis.

As shown in FIGS. 1 to 3, the vertically divided molding machine 1 includes an equipment frame 2, tie bars 3, a fixed mold 4, a fixed mold equipment base 5, a rotating mechanism 6, a movable mold 7, a movable mold equipment base 8, an actuator 9, a coupling mechanism 10, and an injection mechanism (not shown) and a control device (not shown). The following description of the basic configuration of the vertically divided molding machine 1 will be described with reference to the states of FIGS. 1 to 3.

The equipment frame 2 is, for example, a frame body in which a portal frame 21 disposed on the positive side of the Y-axis and a portal frame 22 disposed on the negative side of the Y-axis are coupled to each other by a beam 23. The tie bars 3 extend in the Y-axis direction and are passed through the portal frames 21 and 22 so that the tie bars 3 are bridged over the portal frame 21 disposed on the positive side of the Y-axis and the portal frame 22 disposed on the negative side of the Y-axis.

As shown in FIG. 3, the tie bars 3 are disposed at four corners of a rectangle when viewed from the Y-axis direction. The tie bars 3 are extended when one ends of the tie bars 3 on the positive side of the Y-axis or the negative side of the Y-axis are pulled in while the other ends of the tie bars 3 are fixed, thereby developing a restoring force.

The fixed mold 4 includes a fixed mold body 41 and a fixed mold die base 42. The fixed mold body 41 includes a cavity surface on which a mold is to be formed on a surface of the fixed mold body 41 on the positive side of the Y-axis. A part of the fixed mold body 41 on the negative side of the Y-axis is coupled to the fixed mold base 42.

The fixed mold equipment base 5 is configured in such a way that the fixed mold die base 42 can be coupled thereto. At this time, the fixed mold equipment base 5 is configured in such a way that the coupled state between the fixed mold die base 42 can be released. That is, the fixed mold 4 can be attached to and detached from the fixed mold equipment base 5. The coupling mechanism of the fixed mold 4 and the fixed mold equipment base 5 may be a coupling mechanism used in a common vertically divided molding machine.

The fixed mold equipment base 5 is coupled to the rotating mechanism 6. The rotating mechanism 6 rotates the fixed mold equipment base 5 coupled to the rotating mechanism 6 about the X-axis. The rotating mechanism 6 includes, for example, a rotary shaft 61 connected to the fixed mold equipment base 5 in such a way that a rotary driving force can be transmitted thereto, and a driving source such as a motor connected to the rotary shaft 61. An end of the rotary shaft 61 on the positive side of the X-axis and an end of the rotary shaft 61 on the negative side of the X-axis are rotatably coupled to the equipment frame 2 with fixing jigs 62 interposed therebetween, respectively.

The movable mold 7 includes a movable mold body 71 and a movable mold base 72. The movable mold body 71 includes a cavity surface on which a mold is to be formed on a surface of the movable mold body 71 on the negative side of the Y-axis. A part of the movable mold body 71 on the positive side of the Y-axis is coupled to the movable mold base 72. As shown in FIG. 2, the movable mold base 72 includes a protrusion 72a which protrudes toward the positive side of the X-axis and the negative side of the X-axis with respect to the movable mold body 71.

The movable mold equipment base 8 is configured in such a way that the movable mold die base 72 can be coupled thereto. At this time, the movable mold equipment base 8 is configured in such a way that the coupled state between the movable mold base 72 can be released. That is, the movable mold 7 can be attached to and detached from the movable mold equipment base 8. The coupling mechanism of the movable mold 7 and the movable mold equipment base 8 may also be a coupling mechanism used in a common vertically divided molding machine.

The tie bars 3 are passed through the movable mold equipment base 8. At this time, the movable mold equipment base 8 is configured in such a way that the movable mold equipment base 8 can be fixed to the tie bars 3 with the fixed mold 4 and the movable mold 7 disposed at predetermined intervals.

The movable mold equipment base 8 is coupled to the actuator 9. The actuator 9 moves the coupled movable mold equipment base 8 in the Y-axis direction. The actuator 9 may be composed of, for example, a linear actuator. An end of the actuator 9 on the positive side of the Y-axis is coupled to the equipment frame 2, and an end of the actuator 9 on the negative side of the Y-axis is coupled to the movable mold equipment base 8.

The coupling mechanism 10 couples the fixed mold 4 to the movable mold 7. The coupling mechanism 10 can couple the fixed mold 4 to the movable mold 7, for example, in a state where the cavity surface of the fixed mold 4 and the cavity surface of the movable mold 7 are substantially abutted against each other. The coupling mechanism 10 includes, for example, a clamp. However, the coupling mechanism 10 may be configured in such a way that the fixed mold 4 and the movable mold 7 can be coupled to each other.

The injection mechanism injects sand, molten metal or the like as a raw material of the mold into a cavity formed by the fixed mold 4 and the movable mold 7. The control device controls, for example, the rotating mechanism 6, the actuator 9, the coupling mechanism 10, and the injection mechanism, and controls the attachment and detachment of the fixed mold 4 to and from the fixed mold equipment base 5, and the attachment and detachment of the movable mold 7 to and from the movable mold equipment base 8.

When a mold is formed using such a vertically divided molding machine 1, first, the actuator 9 is controlled in such a way that the cavity surface of the fixed mold 4 and the cavity surface of the movable mold 7 are disposed at predetermined intervals, and then the fixed mold 4 and the movable mold 7 are closed.

Next, the one ends of the tie bars 3 are pulled in and the tie bars are extended, and then the movable mold equipment base 8 is fixed to the tie bars 3 in a state in which a restoring force is developed in the tie bars 3. By doing so, when the raw material is filled in the cavity formed by the fixed mold 4 and the movable mold 7, a predetermined compressive force can be applied to the raw material.

Next, the raw material is injected from the injection mechanism into the cavity formed by the fixed mold 4 and the movable mold 7. After a predetermined time has elapsed, the actuator 9 is controlled to move the movable mold 7 to the positive side of the Y-axis, and then the fixed mold 4 and the movable mold 7 are opened.

At this time, for example, the formed mold is left in the fixed mold 4. Thus, for example, when the rotating mechanism 6 is controlled to rotate the fixed mold 4, the cavity surface of the fixed mold 4 is disposed on the positive side of the Z-axis, and the mold is removed from the fixed mold 4, the molding work of the mold is completed.

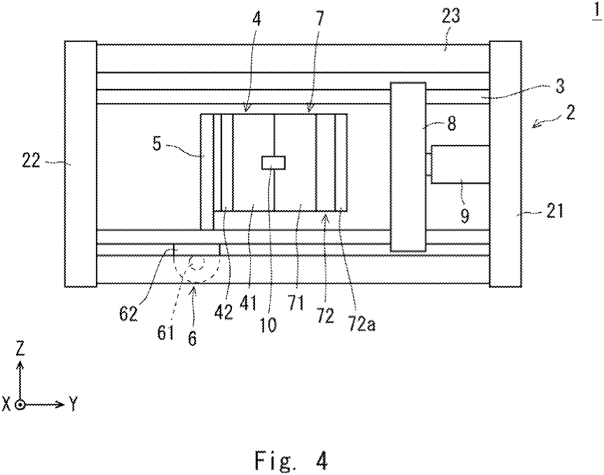

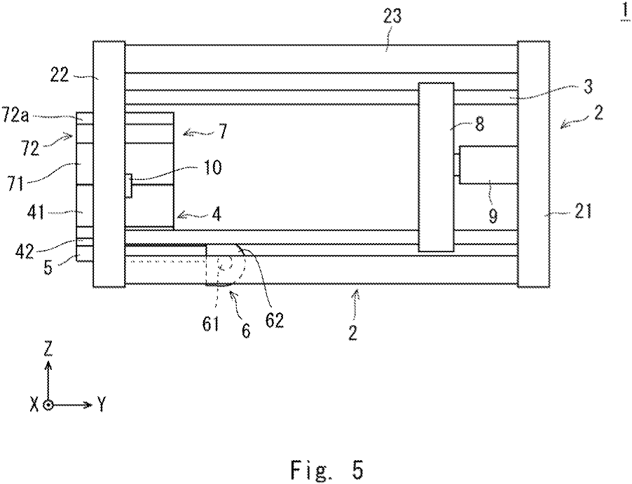

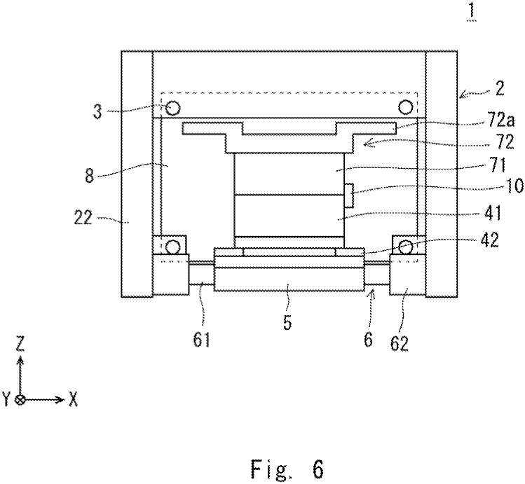

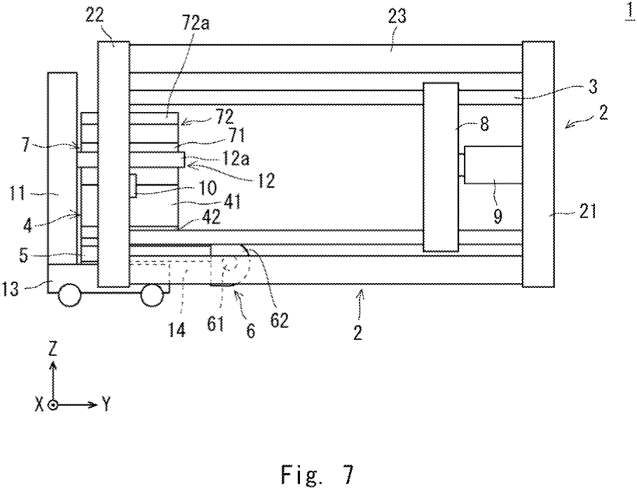

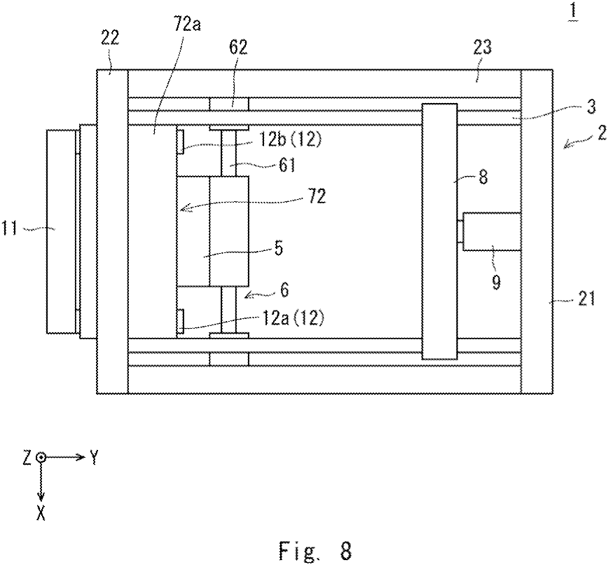

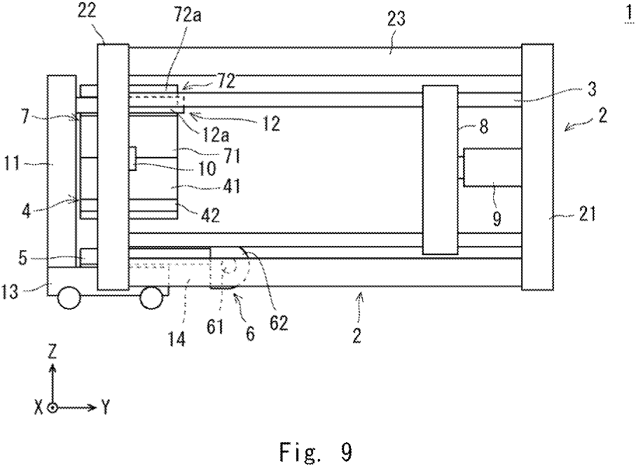

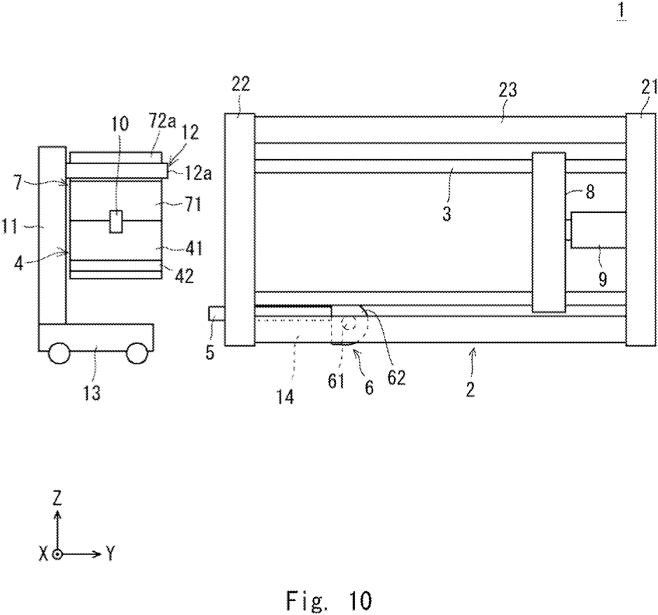

Next, a flow of replacement of the fixed mold 4 and the movable mold 7 in the vertically divided molding machine 1 having the above-described structure will be described. FIG. 4 is a view of a state in which a movable mold is removed from a movable mold equipment base, as viewed from the positive side of the X-axis, in a mold replacement method of the vertically divided molding machine according to this embodiment. FIG. 5 is a view showing a state in which the fixed mold and the movable mold which are coupled to each other are rotated, as viewed from the positive side of the X-axis, in the mold replacement method of the vertically divided molding machine according to this embodiment. FIG. 6 is a view showing a state in which the fixed mold and the movable mold which are coupled to each other are rotated, as viewed from the negative side of the Y-axis, in the mold replacement method of the vertically divided molding machine according to this embodiment. FIG. 7 is a view showing a state in which a protrusion of the movable mold is placed on a fork of a lifting and lowering device, as viewed from the positive side of the X-axis, in the mold replacement method of the vertical dividing molding machine according to this embodiment. FIG. 8 is a view showing a state in which the protrusion of the movable mold is placed on the fork of the lifting and lowering device, as viewed from the positive side of the Z-axis, in the mold replacement method of the vertical dividing molding machine according to this embodiment. FIG. 9 is a view showing a state in which the fixed mold and the movable mold which are coupled to each other are lifted, as viewed from the positive side of the X-axis, in the mold replacement method of the vertically divided molding machine according to this embodiment. FIG. 10 is a view showing a state in which the fixed mold and the movable mold which are coupled to each other is unloaded, as viewed from the positive side of the X-axis, in the mold replacement method of the vertically divided molding machine according to this embodiment.

First, the control device controls the actuator 9 to move the movable mold 7 to the negative side of the Y-axis, and as shown in FIG. 1, the cavity surface of the fixed mold 4 and the cavity surface of the movable mold 7 are substantially abutted against each other. The control device controls the coupling mechanism 10 to couple the fixed mold 4 to the movable mold 7.

Next, the control device releases the coupled state between the movable mold 7 and the movable mold equipment base 8, and then controls the actuator 9 to move the movable mold equipment base 8 to the positive side of the Y-axis as shown in FIG. 4. In this way, the fixed mold 4 and the movable mold 7 in the coupled state are cantilevered and supported by the fixed mold equipment base 5.

Next, the control device controls the rotating mechanism 6 to rotate the fixed mold 4 and the movable mold 7, which are coupled to each other as shown in FIGS. 5 and 6, and to dispose the movable mold 7 on the positive side of the Z-axis with respect to the fixed mold 4. At this time, as shown in FIG. 6, the protrusion 72a of the movable mold 7 is disposed on the positive side of the Z-axis of the fixed mold 4 and the movable mold 7 in the coupled state, and protrudes from the movable mold body 71 toward the positive side of the X-axis and the negative side of the X-axis.

Next, the control device releases the coupled state between the fixed mold 4 and the fixed mold equipment base 5, and unloads the fixed mold 4 and the movable mold 7 in the coupled state by using a lifting and lowering device 11 (see FIG. 7, etc.). Here, the lifting and lowering device 11 includes a fork 12 having a space into which the movable mold body 71 of the movable mold 7 can be inserted and capable of being lifted and lowered in the Z-axis direction. The lifting and lowering device 11 is provided on a carriage 13. At this time, it is preferable that the lifting and lowering device 11 and the carriage 13 can be controlled by the control device.

For example, as shown in FIGS. 7 and 8, the control device controls the carriage 13 so that the lifting and lowering device 11 is brought close to a region of the vertically divided molding machine 1 on the negative side of the Y-axis and then the lifting and lowering device 11 is disposed, and the folk 12 is disposed on the negative side of the Z-axis with respect to the protrusion 72a of the movable mold 7.

That is, while the movable mold body 71 of the movable mold 7 is inserted between a claw 12a on the positive side of the X-axis and a claw 12b on the negative side of the X-axis of the fork 12, the claw 12a on the positive side of the X-axis is disposed on the negative side of the Z-axis with respect to the protrusion 72a on the positive side of the X-axis of the movable mold 7, and the claw 12b on the negative side of the X-axis is disposed on the negative side of the Z-axis with respect to the protrusion 72a on the negative side of the X-axis of the movable mold 7.

At this time, a part of the carriage 13 on the positive side of the Y-axis may be inserted into an insertion part 14 formed in the fixed mold equipment base 5 on the negative side of the Z-axis. This makes it possible to reduce the lengths of the claws 12a and 12b of the fork 12 in the Y-axis direction as compared with the case where the part of the carriage 13 on the positive side of the Y-axis is not inserted into the insertion part 14 formed in the fixed mold equipment base 5 on the negative side of the Z-axis.

Furthermore, when the fixed mold 4 and the movable mold 7 in the coupled state are supported by the fork 12 as described later, the fixed mold 4 and the movable mold 7 in the coupled state can be supported at positions close to the center of gravity of the carriage 13, and thus it is possible to support the fixed mold 4 and the movable mold 7 which are stably coupled to each other.

Next, for example, the control device controls the lifting and lowering device 11 to lift the fork 12, and as shown in FIG. 9, to place the protrusion 72a of the movable mold 7 on the claws 12a and 12b of the fork 12, and then to lift the fixed mold 4 and the movable mold 7 in the coupled state while the fork 12 is supporting the fixed mold 4 and the movable mold 7 in the coupled state.

Next, for example, when the control device controls the carriage 13 to remove the fixed mold 4 and movable mold 7 in the coupled state from the fixed mold equipment base 5 as shown in FIG. 10, unloading of the fixed mold 4 and movable mold 7 in the coupled state is completed.

After that, by performing a flow of steps reverse to the flow of steps for unloading the fixed mold 4 and the movable mold 7, a new fixed mold 4 and a new movable mold 7 can be loaded, and the fixed mold 4 and the movable mold 7 can be replaced accordingly. Specifically, first, the cavity surface of the new movable mold 7 is substantially abutted against the cavity surface of the new fixed mold 4, and the fixed mold 4 and the movable mold 7 are coupled to each other by the coupling mechanism 10.

Next, for example, the control device controls the lifting and lowering device 11 to place, on the fork 12, the protrusion 72a of the movable mold 7 disposed on the positive side of the Z-axis with respect to the fixed mold 4 and support the fixed mold 4 and the movable mold 7 in the coupled state by using the fork 12. Next, the control device controls the carriage 13 to load the fixed mold 4 and the movable mold 7 in the coupled state to the positive side of the Z-axis of the fixed mold equipment base 5.

Next, for example, the control device controls the lifting and lowering device 11 to lower the fixed mold 4 and movable mold 7 in the coupled state, to place the fixed mold 4 and movable mold 7 in the coupled state on the fixed mold equipment base 5, and to couple the fixed mold 4 to the fixed mold equipment base 5.

Next, the control device controls the rotating mechanism 6 to rotate the fixed mold 4 and movable mold 7 in the coupled state, and arrange the fixed mold 4 and the movable mold 7 side by side in the Y-axis direction. That is, the cavity surface of the fixed mold 4 is disposed on the positive side of the Y-axis, and the cavity surface of the movable mold 7 is disposed on the negative side of the Y-axis.

Next, the control device controls the actuator 9 to move the movable mold equipment base 8 to the negative side of the Y-axis, and couples the movable mold 7 to the movable mold equipment base 8. By doing so, the new fixed mold 4 and movable mold 7 can be installed in the vertically divided molding machine 1. In this manner, the fixed mold 4 and the movable mold 7, which are to be replaced, can be replaced with the new fixed mold 4 and movable mold 7.

As described above, in the mold replacement method according to this embodiment, the fixed mold 4 and the movable mold 7 are unloaded from the vertically divided molding machine 1 in a state in which the fixed mold 4 and the movable mold 7 are coupled to each other, and thus it is possible to contribute to simplification of a work of unloading the fixed mold 4 and the movable mold 7 as compared with the case in which the fixed mold 4 and the movable mold 7 are unloaded separately.

In addition, in the mold replacement method according to this embodiment, the fixed mold 4 and the movable mold 7 are loaded in the vertically divided molding machine 1 in the coupled state, and thus it is possible to contribute to simplification of a work of loading the fixed mold 4 and the movable mold 7 as compared with the case in which the fixed mold 4 and the movable mold 7 are loaded separately. In this manner, the mold replacement method according to this embodiment can improve the workability when the fixed mold 4 and the movable mold 7 are replaced.

Moreover, in the mold replacement method according to this embodiment, the fixed mold 4 and the movable mold 7 are loaded or unloaded in the coupled state by using the protrusion 72a of the movable mold 7, and thus the fixed mold 4 and the movable mold 7 in the coupled state can be loaded or unloaded by using the small lifting and lowering device 11 having the fork 12. Therefore, it is possible to contribute to saving a space of the equipment where a mold is formed as compared with the case where the fixed mold 4 and the movable mold 7 are loaded or unloaded by using a large lifting and lowering device such as a hoist crane.

Furthermore, in the mold replacement method according to this embodiment, since the fixed mold 4 and the movable mold 7 are rotated in the coupled state by using the coupling mechanism 10, the arrangement of the fixed mold 4 and the movable mold 7 can be easily changed according to the flow of steps for unloading or loading the fixed mold 4 and the movable mold 7.

The present disclosure is not limited to the above-described embodiment, and may be modified as appropriate without departing from the spirit.

For example, in this embodiment, the new fixed mold 4 and the new movable mold 7 are installed in the vertically divided molding machine 1 in a flow of steps reverse to the flow of steps for unloading the fixed mold 4 and the movable mold 7. However, the flow of steps for installing the new fixed mold 4 and the new movable mold 7 in the vertically divided molding machine 1 is not particularly limited.

For example, in this embodiment, the fixed mold 4 and the movable mold 7 are supported by the lifting and lowering device 11 in a state where the fixed mold 4 and the movable mold 7 are coupled to each other after the coupled state between the fixed mold 4 and the fixed mold equipment base 5 is released. However, a flow of steps is not limited to this as long as the coupled state between the fixed mold 4 and the fixed mold equipment base 5 is released when the fixed mold 4 and the movable mold 7 in the coupled state are unloaded from the fixed mold equipment base 5.

For example, although the vertically divided molding machine 1 according to this embodiment includes the tie bars 3, the tie bars 3 may be omitted.

For example, although the fixed mold 4 according to this embodiment includes the fixed mold body 41 and the fixed mold base 42, the fixed mold base 42 may be omitted. Similarly, although the movable mold 7 according to this embodiment includes the movable mold body 71 and the movable mold base 72, the movable mold base 72 may be omitted.

For example, although the carriage 13 according to this embodiment can be controlled, that is, can be moved by a driving source, the carriage 13 may be moved by human power. Furthermore, the lifting and lowering device 11 is not necessarily configured to be controlled by the control device as long as the lifting and lowering device 11 is configured to lift or lower the fork 12.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A mold replacement method of a vertically divided molding machine comprising:
a fixed mold;
a fixed mold equipment base to which the fixed mold is coupled;
a movable mold; and
a movable mold equipment base to which the movable mold is coupled and which is configured to be capable of being brought close to and being separated from the fixed mold equipment base, the mold replacement method comprising:
coupling the fixed mold to the movable mold;
releasing a coupled state between the movable mold and the movable mold equipment base;
rotating the fixed mold and the movable mold in the coupled state by a rotating mechanism for rotating the fixed mold equipment base, and disposing the movable mold above the fixed mold;
releasing the coupled state between the fixed mold and the fixed mold equipment base; and
unloading the fixed mold and movable mold in the coupled state from the fixed mold equipment base while a protrusion protruding outward from the movable mold is being supported by a fork of a lifting and lowering device.

2. The mold replacement method according to claim 1, further comprising:
coupling the fixed mold to the movable mold;
loading, in the fixed mold equipment base, the fixed mold and the movable mold in the coupled state while the protrusion of the movable mold disposed above the fixed mold is being supported by the fork of the lifting and lowering device;
coupling the fixed mold to the fixed mold equipment base;
rotating the fixed mold and the movable mold in the coupled state by the rotating mechanism, and disposing the fixed mold and the movable mold side by side; and
coupling the movable mold to the movable mold equipment base.

3. The mold replacement method according to Claim1, wherein the lifting and lowering device is provided on a carriage.

4. The mold replacement method according to claim 3, further comprising:
inserting the carriage into an insertion part formed in a lower part of the fixed mold equipment base when the carriage is brought close to the fixed mold equipment base.
